(19) United States
(12) Patent Application Publication
(10) Pub. No.: US 2021/0118077 A1
(43) Pub. Date: Apr. 22, 2021

(54) PERSONAL SECURITY MONITORING

(71) Applicant: Todd M. Kuta, Chesterton, IN (US)

(72) Inventor: Todd M. Kuta, Chesterton, IN (US)

(21) Appl. No.: 17/067,666

(22) Filed: Oct. 10, 2020

Related U.S. Application Data
(60) Provisional application No. 62/916,098, filed on Oct. 16, 2019.

(51) Int. Cl. G06Q 50/26; H04L 29/06; G06Q 50/00; G06Q 10/10; G06Q 20/22; G06Q 10/06; G06N 5/04; H04L 29/08; G06K 9/00

(52) U.S. Cl. CPC G06Q 50/265; H04L 63/30; H04L 63/0861; G06Q 50/01; G06Q 10/10; H04L 67/20; G06Q 10/06315; G06Q 10/06311; G06N 5/04; H04L 67/306; G06K 9/00288; G06Q 20/223

(57) ABSTRACT

Computer-implemented services provide personal security monitoring and/or oversight of interactions between parties that may be initiated online, and in some circumstances extended to real-world in-person interactions. Profiles associated with individuals involved in a transaction may be developed and centrally managed. Profiles may contain, e.g., information concerning a user's identity, historical and/or current location information, user communication information, and the like. Profile information may be used by a central security oversight platform and/or provided to third party systems for, e.g., assessing risks involved in a particular interaction, providing accountability amongst users, and assisting law enforcement or third parties in transaction intercession and/or investigation in the event that an interaction results in negative consequences.

### TECHNICAL FIELD

Embodiments of the present disclosure relate in general to security monitoring services, and more particularly, to a system and method of providing oversight to interactions between parties who have little familiarity with each other in uncontrolled environments.

### BACKGROUND

As technology has evolved, the way in which people interact and/or communicate with one another has changed dramatically. Social media is a guiding force in much of our daily lives. The internet, which evolved from brochureware to B2B to B2C, has now become a part of an integrated platform of technologies which generally interface with ubiquitous personal devices, including smartphones and tablet computers. The expansion of our interconnected world continues to grow at a rapid pace with smart homes, cars, and personal assistants all interfacing with our personal devices. This transformation, coupled with expansive changes in social acceptance of how the interconnected world interacts with our daily lives, has created a shadow world that resides between the anonymity of the cyberworld/social media and the bricks and mortar world where are physical being resides.

The explosion of the internet, phone/tablet applications, and social media has created a world of opportunity for efficiencies, commerce, and communication. It has also created a world of unintended consequences which arise from new types of real-life interactions between parties who have little familiarity with each other in uncontrolled environments. For example, traditional commerce interactions between unknown individuals largely took place in controlled environments, such as retail stores. However, online platforms are now commonly used by individuals to arrange transactions with unknown individuals (whether purchase of goods, providing of driving services, hotel services or other types of interactions) in private residences or other locations, without little or no regulatory oversight. The explosion of these interactions continues to lead to negative outcomes, such as misaligned expectations amongst interaction participants, dishonesty or fraud, and in some circumstances even violent crimes such as assault, rape, kidnappings, and murder.

Accordingly, it would be highly desirable to provide a new and improved system and method of providing oversight to said interactions, towards potentially reducing the frequency and significance of negative outcomes.

### SUMMARY

One approach to reducing the frequency or severity of undesirable outcomes involves implementing a system for providing oversight to interactions. This oversight will first and foremost serve as a deterrent to premeditated bad actions. Secondly, the system may provide a sense of security to those party to the interaction as well as those stakeholders and loved ones who are not a part of the interaction. In addition, the system may provide law enforcement with a strong set of tools that can aid in the intercession of a crime or incident in-progress and apprehension of bad actors, provide legal information for case resolution, and assist in the asset allocation for interactions which did not come to a successful conclusion.

In accordance with some embodiments, systems, methods and devices are described herein for facilitating and providing security oversight of interactions between individuals. Profiles may be developed for individuals involved in an interaction. Profile information may be used to assess risks involved in an interaction, provide user accountability, and assist law enforcement or other third parties in the event that an interaction results in negative consequences. A profile may be created for an interaction, including information such as pre-interaction photos, GPS coordinates, cell tower triangulation, contact list, phone history, email history, texts history, and GPS history. A pre-defined escalation path may be implemented in the event that interaction parameters are breached. The interaction profile and/or user profiles may be provided to law enforcement agencies should interaction parameters be breached. Facial recognition biometrics may be used in conjunction with a mobile device internal application selfie function to provide pictures of interaction participants to said participants and as part of interaction profile should parameters be breached.

Various other objects, features, aspects, and advantages of the present invention and embodiments will become more apparent from the following detailed description of preferred embodiments, along with the accompanying drawings in which like numerals represent like components or elements.

### BRIEF DESCRIPTION OF THE FIGURES

FIG. 1 is a schematic block diagram of a computing environment.

FIG. 2 is a schematic block diagram of a user computing device.

FIG. 3 is a schematic block diagram of individuals involved in a monitored interaction.

FIG. 4 is a flow chart of a process for monitoring P2P user interactions.

FIG. 5 is a flow chart of a process for initiating a monitored P2P user interaction.

FIG. 6 is a schematic block diagram of individuals involved in an interaction monitored via direct integration with a third-party application platform.

FIG. 7 is a flow chart of a process for use of interaction risk assessments.

FIG. 8 is a flow chart of a process for oversight of in-person interactions.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

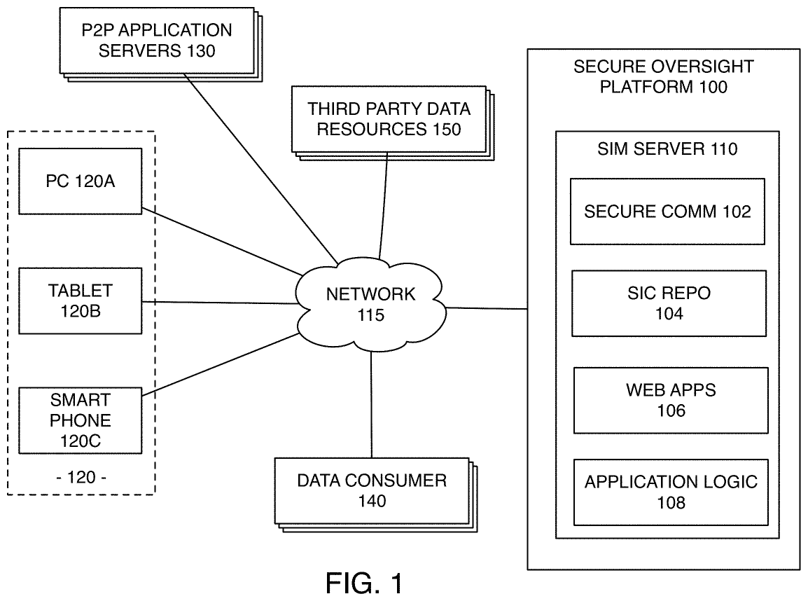

FIG. 1 is schematic block diagram of an exemplary online application environment. Secure Oversight Platform server 100 (SOP 100) includes Secure Interaction Manager server 110 (SIM 110), which communicate, inter alia, via computer network 115 (e.g. a wide area data network which may include the Internet) with user devices 120 (such as personal computer 120A, tablet computer 120B and smart phone 120C), and with P2P application servers 130, data consumers 140, and third party data resources 145.

SOP 100 implements interaction security and monitoring services for unfamiliar parties engaging in a peer-to-peer (P2P), and in some use cases face-to-face, interactions. Such services may be embedded within, and/or used in conjunction with, existing (and potentially third-party) application platforms that are instantiating such P2P interactions. SOP 100 is preferably implemented using one or more cloud-based servers, and includes SIM 110. SIM 110 enables users (e.g. of devices 120) to, inter alia, issue social engagement invites on various applications and securely conduct timestamped in-app communications over mobile channels. Functional components implemented by SIM 110 include secure communications component 102, secure in-app repository 104, any number of web applications 106, and other application logic 108. As used herein, “web applications” as implemented by SIM 110 may include components otherwise sometimes referred to as applets and APIs. Further details regarding both SIM 110 and SOP 100 are set forth hereinbelow.

While certain illustrated embodiments are implemented using smartphones, tablets or other mobile devices as user devices, it is contemplated and understood that embodiments may also be used with any other device that a user may use to access digital communication services, including, without limitation, smart watches, smart glasses, tablet computers, Internet-connected automobiles, IoT-enabled devices, and the like.

SOP 100 and SIM 110 may be implemented using a variety of hardware and software computing resources, as are well known in the field of web-based applications. Regardless, at some level, SOP 110 and SIM 110 will typically implement application logic, and operate to store information within, and retrieve information from, a database or other datastore. The term “database” is used herein broadly to refer to an indexed store of data, whether structured or not, including without limitation relational databases and document databases. Application logic may host one or more Internet web sites and/or Application Programming Interfaces (APIs) enabling outside user interaction with, amongst other things, secure communications component 102, secure in-app repository 104, web applications 106, and other application logic 108.

P2P application servers 130 are network-connected application platforms enabling various types of peer-to-peer interactions, such as direct messaging, social media features, merchandise sales, dating, ride sharing, or the like. P2P application servers 130 may interact with SIM 110 and/or SOP 100 in order to implement enhanced user verification or authentication functions, security functions, and/or interaction monitoring; however, applications servers 130 may otherwise be independently operable.

Data consumer devices 140 include devices or systems operated by parties desiring access to information managed by SOP 100, other than P2P applications associated with servers 130. Examples may include, for example, law enforcement services, as described further elsewhere herein.

Third party data resources 145 are network-connected servers providing data access services, such as criminal background checks, credit checks, address verification, identity verification, or the like. Third party data resources 145 may be accessed by SOP 100 (e.g. via API) to, e.g., obtain additional information for user security profiles, as described elsewhere herein. Third party systems and data resources may also access and interact with SOP 100 via API, including interactions similar and/or comparable to those implemented between SOP 100 and various user electronic devices.

While depicted in the schematic block diagram of FIG. 1 as block elements with limited sub elements, as known in the art of modern web applications and network services, servers 100, 110, 130 and 145 may be implemented in a variety of ways, including in a distributed computing environment where tasks are performed by remote processing devices that are linked through a communications network. In a distributed computing environment, program modules may be located in either or both local and remote computer storage media including memory storage devices. That said, the implementation of servers 100, 110, 130 and 145 will typically include, at some level, one or more physical servers, at least one of the physical servers having one or more microprocessors and digital memory for, inter alia, storing instructions which, when executed by the processor, cause the server to perform methods and operations described herein.

Typically, servers 100, 110 and/or 130 may interact with user devices 120 to render a user interface, enabling communication of information to users of devices 120 and interaction between user devices 120 and servers 100, 110 and/or 130. Examples of user interfaces may include, inter alia, a mobile app graphical user interface rendered on a touch-sensitive display screen of a smartphone; or a web application rendered on web browser software running on a personal computer equipped with a keyboard and mouse. These and other embodiments facilitate implementation of methods and systems described herein.

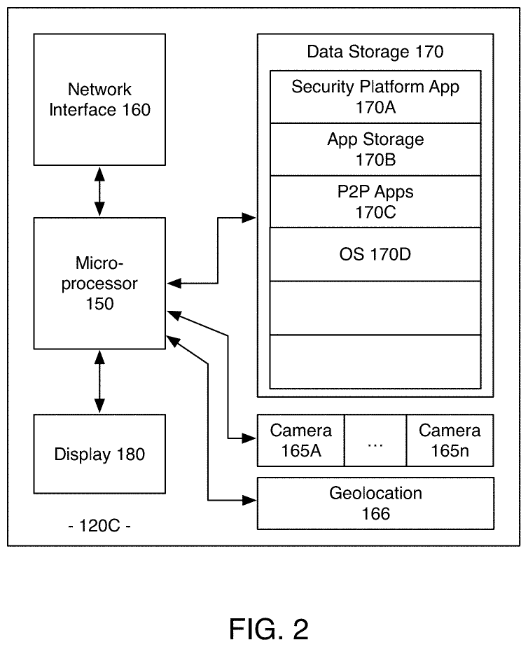

FIG. 2 is a schematic block diagram of an exemplary user device, smart phone 120C. Smart phone 120C includes microprocessor 150. Microprocessor 150 is configured to transfer data back and forth with data storage 170. Data storage 170 includes, inter alia, security platform application 170A, application storage 170B, P2P services application(s) 170C, and operating system software 170D. Security platform application 170A enables interaction between user device 120C, SIM 110 and/or SOP 100, and may be implemented via, e.g., a locally-installed application and/or a web application implemented using web browser software. Application storage 170B stores user content that may be made available to, e.g., security platform app 170A and P2P apps 170C. P2P apps 170C contains instructions that can be executed by microprocessor 150 to implement various platforms involving P2P communications or P2P transactions, such as ride sharing apps, social networking apps, online classified ad apps and the like. In addition to or in lieu of standalone, locally-installed applications, P2P apps 170C may include a general purpose web browser application operating via one or more web sites to implement an online P2P service (e.g. via a “web app”). Operating system software 170D contains instructions that can be executed by microprocessor 150 to implement a computing device operating system.

Device 120C further includes digital cameras 165A-n, capable of recording digital images and digital video content within video and image storage 170B. Digital cameras 165 may include, for example, a front-facing camera and one or more rear-facing cameras. Network interface 160 enables device 120C to send and receive data communications with external networks (e.g. a wide area data network which may include the Internet). Network interface 160 may include common communication mechanisms including, without limitation, a cellular modem, Bluetooth interface, wireless Ethernet interface and/or other type of wireless transceiver. Geolocation component 166 may enable device 120C to identify and reports its geolocation, such as may be provided by GPS, AGPS, or other geolocation mechanisms. Touchscreen display 180 enables user interaction with device 120C.

It should be appreciated by those of ordinary skill in the art that FIGS. 1 and 2 depict the various computing devices and environments in a simplified manner for purposes of clarity, and practical embodiments may include additional components and suitably configured processing logic to support known or conventional operations and functionality not described in detail herein.

Security Oversight Platform with SIM

SOP 100 can be utilized by end users (e.g. users of devices 120, and particularly mobile devices 120C) via P2P app 170A. Amongst other things, SOP 100 may enable a user to manage one security profile for use across multiple applications or platforms (e.g. multiple applications implemented by P2P servers 130). SOP 100 may be particularly valuable for use in connection with web and/or social media platforms that create interactions between unfamiliar parties. Examples include platforms facilitating peer-to-peer or other commercial transactions (e.g. Craigslist™, Autotrader.com™, Century21™), and various online dating platforms such as dating services provided by Match Group/IAC. While SOP 100 and SIM 110 are illustrated in FIG. 1 as separate components, it is contemplated and understood that in other embodiments, the functionality of these components may be readily combined for implementation together, or subdivided across yet other servers or platforms. Moreover, in yet other embodiments, the components of SOP 100 and SIM 110 may be readily implemented via servers or compute resources that also implement different or additional functions.

SIM 110 may be utilized to manage and improve user-to-user interactions provided by P2P servers 130. SIM 110 may enable users to issue social engagement invites on various other applications, and to securely have timestamped in-app communications over mobile channels with mobile device end users. Major functions of SIM 110 may include interaction lifecycle management (which may be implemented by secure communications module 102), a secure repository for in-app communications (implemented by Secure In-App Communication Repository (SICR) module 104), and various application-specific functionality (i.e. web applications 106). SIM 110 enables installation, personalization and deletion of web applications 106 and security domains (SDs) for secure communication functions.

Another function of SIM 110 may be maintaining a Common Body of Knowledge (CBK) for user interactions that are managed by SOP 100. The CBK may be stored, for example, by SICR 104, and may include access control information for secure interactions (e.g. identification, authentication, authorization, accounting & tracking). The CBK may also include telecommunications and network security data, such as: network security protocols, network authentication services, data encryption services, firewall services, communications security management, intrusion detection services, intrusion prevention systems, fault tolerance information for data availability (e.g. backups, redundant disk systems), acceptable logins and operating process performance, and security processes and network security mechanisms. The CBK may include information security governance and risk management information, such as security governance policies, information classification and/or ownership, contractual agreements and procurement policies, risk management information, personnel security details, security education/training/awareness information, and certifications and accreditations.

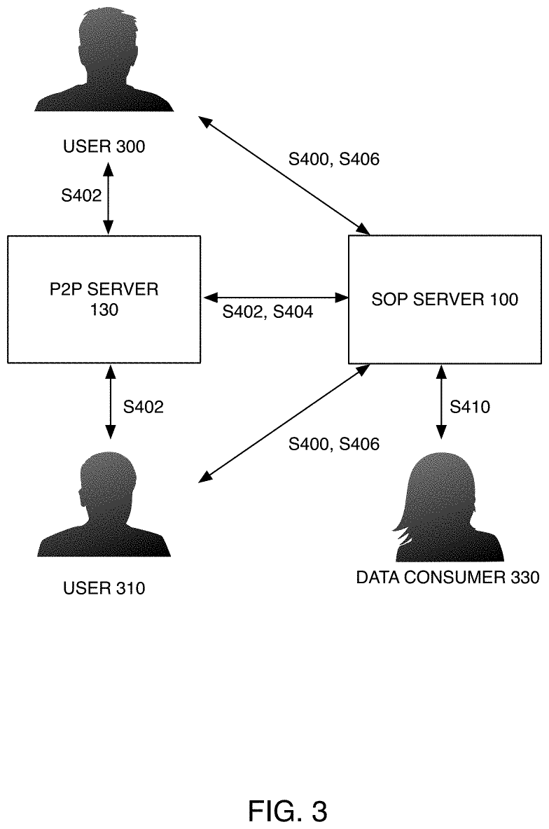

FIG. 3 is a schematic block diagram of parties involved in an exemplary embodiment and use cases described herein. User 300 and user 310 may be, for example, users of a P2P service (such as a ridesharing service, dating service or classified ad service) implemented by server 130. SOP server 100 (which may include SIM 110) interacts with P2P server 130, and directly with user 300 and user 310. Data consumer 330 may also interact with SOP 100, as described herein.

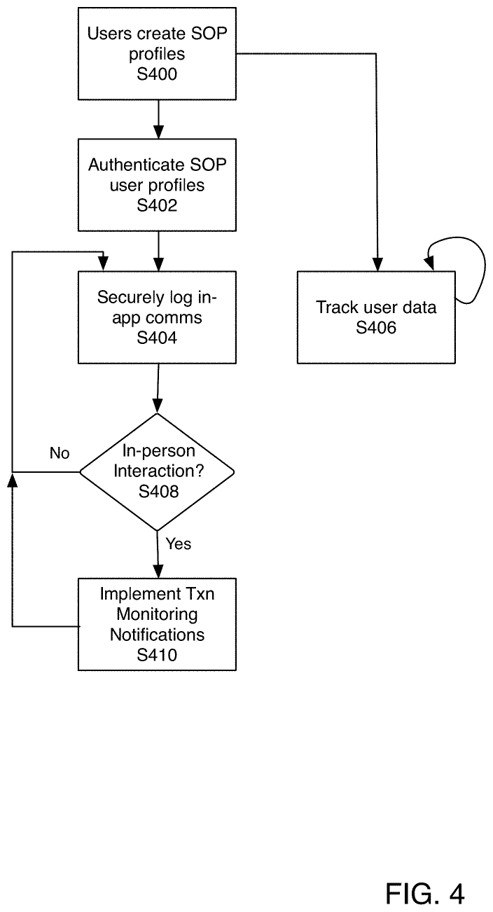

FIG. 4 is a flow chart of a process for implementing a secure interaction amongst user 300 and user 310, in the context of FIG. 3. The process of FIG. 4 can be implemented by, for example, the parties of FIG. 3, using devices such as that of FIG. 2, and in a computing environment such as that of FIG. 1.

In particular, FIG. 4 illustrates a process for SOP 100 to manage the security of interactions initiated by users directly within a third-party P2P application. In step S400, user 300 and user 310 each create a user profile with SOP 100. When users initially create a profile with the security oversight platform, the user may be taken through an account onboarding process that requires providing of certain personal information, i.e. essential profile information. Preferably, essential profile information includes personally-identifiable information. Essential profile information may include: full name, age, gender, primary address, and one or more phone numbers. Other demographic and personal information may also be required.

Users may be required to associate biometric data with their profiles, for secure storage within SICR 104. Such biometric data may include, for example, a photograph of the user's unobscured face, such as may be taken in real time by a mobile device 120C using one of cameras 165, preferably taken under the control of security platform app 170A to provide some authentication concerning the source and timing of the image capture. In some embodiments, biometric data such as a photograph may be taken at the time of user profile configuration, and again at subsequent times such as the time of a monitored interaction. Such biometric data may be compared to provide, e.g., automated authentication (such as via image comparison implemented by security platform app 170A or centrally by SIM application logic 108). Such biometric data, particularly photographic biometric data, may also be revealed to other users with which an interaction takes place, such as to provide the other users with a means of authenticating the identity of the individual with whom an interaction is conducted. Photographs and other biometric data may be transmitted from device 120 to SIM 110 for storage within SICR 104 each time it is taken, thereby building a biometric profile over time.

In step S402, user 300 and user 310 each authenticate SOP 100 user profiles with P2P server 130. By requiring both users to have user profiles maintained by SOP 100, the process of FIG. 4 is a double opt-in process, with both users involved in an interaction having to agree to use of SOP 100 to manage the interaction. Some P2P services implemented by a server 130 may require users to utilize SOP 100. Other P2P services may not want to limit users to interactions that utilize SOP 100. However, the security benefits of interaction oversight may encourage user participation using SOP 100, with some users potentially being inhibited from interacting with others not willing to utilize SOP 100 for interaction management. Some platforms may experience a critical participation level at which the added availability of users of SOP 100 for interactions may greatly encourage most or all good-faith actors to allow SOP 100 to manage interactions, and thereby unlock the full value of P2P service 130.

In step S404, communications between users associated with profiles on SOP 100 (e.g. user 300 and user 310) are securely relayed to, and logged by, SOP 100. In particular, server 130 may relay communications between user 300 and user 310 for association with user profiles for each of them, and/or incorporation into an interaction security record for an interaction in which such a user is involved.

Simultaneously SOP 100 develops and populates a user profile for each registered user (including user 300 and user 310) (step S406). Population of user data in step S406 may include, without limitation, tracking of user location such as location information determined by GPS services in user device 120C and reported using device location services, or in some embodiments via interaction of security platform app 170A with device geolocation sensors (such as AGPS) and/or mobile device platform location-based services. Location-related data may also include information indirectly associated with location, such as network names and/or network IDs of WiFi networking equipment observed by a user's mobile device. In some circumstances, users may agree to continuous secure tracking of user data, such as location, by SOP 100. In some circumstances, users may agree to tracking of user data during, or proximate the time of, an in-person interaction arranged via P2P server 130; in such circumstances, server 130 may communicate interaction information regarding users authenticated in step S402 to SOP 100, in order to initiate, terminate or modify the collection of data by SOP 100 in step S406.

In step S408, a determination is made as to whether server 130 has coordinated an in-person interaction between user 300 and user 310. If not, server 130 continues relaying in-app interactions to SOP 100 for secure storage. If so, SOP 100 may implement a transaction monitoring and notification process (step S410). Step S410 may include, for example, transaction monitoring by third party data consumers (optionally, in some embodiments, including law enforcement authorities), and/or various automated notification and escalation processes, both of which are described further hereinbelow.

SOP 100 may utilize a variety of subprocesses, systems and techniques for overseeing in-person interactions amongst users. The particular interaction oversight functions may be determined by, for example, user preferences, transaction characteristics, local considerations, and the like.

Transaction Monitoring by Third Party Data Consumers

In some embodiments, the occurrence of in-person transactions (such as the date, time and place of such transactions) may be published to a transaction monitoring system utilized by data consumers 330, which may include law enforcement agencies (including prosecutors) utilizing such information to maximize the efficiency and cost-effectiveness with which law enforcement agencies protect public safety, deter crime and/or bring wrongdoers to justice. For example, a local police department may be provided with a web portal implemented by SOP 100 (such as via a web application 106 configured for local information reporting), mapping a heat map of the locations and volumes of in-person interactions. Such a police department data consumer 330 may utilize that information to deploy resources appropriately to maximize police presence during higher-risk interactions, deter crime, and/or minimize response time or maximize response effectiveness in the event that such an interaction leads to a criminal act. Such a portal, and information provided therein, may be accessible directly by law enforcement officers, e.g. from a tablet computer located within a dispatched police vehicle. In some embodiments, the transaction monitoring information described herein may be delivered via other mechanisms than a web portal; for example, in some embodiments, law enforcement authorities may receive reports and notifications via email (i.e. forwarding reports or notification links to a police-maintained email server), SMS or in app notifications. Such reports and notifications may be delivered in response to predetermined criteria, such as those described elsewhere herein for escalation of interaction notifications. In some embodiments, escalation criteria for initiating law enforcement notifications may be determined by users involved in a monitored interaction, e.g. by prior agreement and/or with all interaction participants' prior knowledge of the criteria.

In another exemplary application, interaction monitoring and management capabilities of SOP 100 may be applied by a data consumer 330 such as a law enforcement authority, to monitor compliance with restraining orders, such as court or administrative orders requiring a restrained individual to remain at least a minimum physical or geographic distance from a protected individual. The real-time or near-real-time locations of restrained and protected individuals may be logged by SOP 100 and reported out via, e.g., a web-based portal implemented via a web application 106. Messaging and/or notification services implemented by, e.g., secure communications module 102 may proactively alert data consumer 330 (e.g. law enforcement officers) in the event that the distance between a restrained and associated protected individual falls below a minimum threshold. A restrained individual may be required to periodically perform a biometric check-in using a mobile device 120C (such as via an integrated fingerprint sensor, camera-based (using camera 165A) or laser-based (using integrated laser sensors) facial recognition, etc.) to authenticate the restrained individual's location.

As described further elsewhere herein, a security profile maintained by SOP 100 may include a variety of information descriptive of an individual user, such as name, home address, work address, personal photo, identity information (such as driver's license or social security number), physical descriptors (e.g. height, weight, skin color, hair color), frequent locations and travel routes, personal real-time or last-known location information, criminal background check information, or the like. Some information utilized for user security profiles may be obtained by SOP 100 from third party data resources 145. For example, a third-party data resource 145 may comprise an automated background check service, in which case SOP 100 may utilize information queried from a user to retrieve background check information for storage in SICR 104 and association with a user security profile. In other cases, a third-party data resource 145 may be a public database, such as a property ownership database, from which user-authenticating information may be retrieved by SOP 100.

While SOP 100 is preferably implemented to avoid or minimize criminal acts or wrongdoing, in the event that a criminal act occurs and must be investigated, information associated with system participants may be made directly available to a law enforcement officer in the field (e.g. to aid in timely intercession and aid to a victim) and/or to prosecutors involved in prosecuting criminal actions. Such information may be useful to help locate, accurately identify and prove or disprove the guilt of suspected perpetrators. Such information may also be helpful to assist law enforcement officers in taking actions that maximize the safety of the public, the suspected perpetrators, and the officers themselves; for example, a law enforcement officer seeking to engage with a suspect that is physically imposing or has a history of aggressive behavior, may be prompted to call for appropriate backup before engaging the suspect.

The content and format of data reported by SOP 100 to data consumers 330 using data consumer systems 140 may be determined by, for example, an individual user (i.e. user-specific preferences or preferences of a customer on behalf of whom data consumer 330 acts), or by one or more user classifications (e.g. whether the user is a police officer or prosecutor; the law enforcement agency to which the user belongs; or the location of the user). In this way, content reporting may be crafted to maximize the admissibility or usefulness of data for a particular application. For example, information may be made available in a format determined at least in part by local legal requirements.

Interaction Monitoring Through Security Platform Application

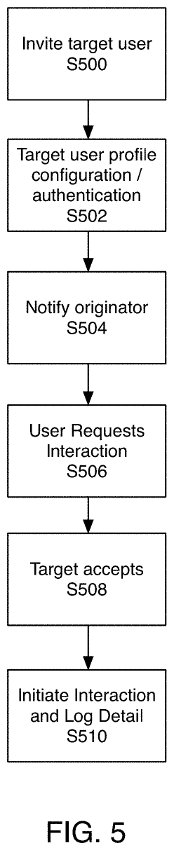

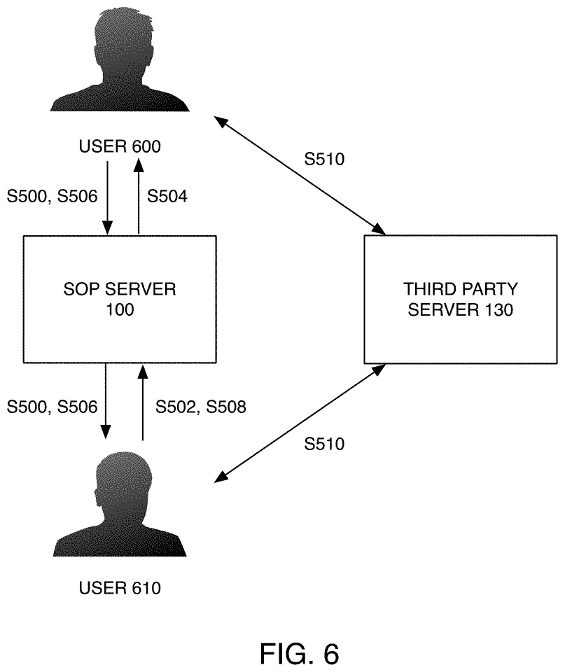

In addition to or in lieu of direct integration with third party P2P platforms, mobile device security platform app 170A may be utilized to initiate and/or conduct secure, monitored, user-authenticated communications via third party communication platforms, potentially utilizing operating system integrations provided by such platforms. FIG. 5 illustrates such a process, which may be implemented in connection with the entities illustrated in FIG. 6, again using the communications infrastructure of FIG. 1 and user devices of FIG. 2.

In step S500, a first user 600 invites a second user 610 to engage in security-monitored communications using SOP 100. For example, first user 600 may request that a second user 610 agree to use of an interaction oversight platform for a particular interaction. User 600 may request a telephone number from user 610. User 600 may utilize, e.g., security platform application 170A on a mobile device 120C in order to initiate an invitation to the security platform implemented by SOP 100. The invitation may be transmitted via SMS as a URL.

In step S502, user 610 accepts the engagement invitation of step S500. If user 610 has not yet created a profile with SOP 100, the user may be prompted to create such a profile (e.g. by downloading a mobile app and entering relevant information). If user 610 has previously created a profile within SOP 100, user 610 may instead be prompted to authenticate with SOP 100. In step S504, user 600 is notified that target communication recipient user 610 has accepted the interaction request of step S500.

In step S506, an initiating user (e.g. user 600) submits an interaction request to SOP 100, using security platform app 170A, specifying an interaction type and target user (e.g. user 610). Interaction requests may include, e.g., an in-person meeting, or requests for communications via third party messaging or communication platforms, such as Skype, Zoom, WhatsApp, FaceTime, SMS messaging, iMessage, mobile phone calls, VOIP telephone calls, emails, or the like. In some embodiments, interaction requests may be submitted by any user to any other user, although SOP 100 may require a prior connection between users (such as a social graph connection as may have been previously established in step S500). In step S508, the target user 610 accepts the interaction request, the acceptance being communicated from user device 120 to SOP 100.

In step S510, the specified interaction is initiated with interactions details logged by SOP 100 into a security interaction record containing information regarding the interaction and its participants. In addition to information logged during an interaction, the security brief stored by SOP 100 may include, inter alia, previously-configured profile information concerning interaction participants. In some embodiments, data may also be queried from mobile devices used by interaction participants (e.g. mobile device 120C), such as location data stored before, during or after an interaction (e.g. data procured by geolocation component 166 and stored within data storage 170).

In some circumstances, for electronic communications between users, security platform app 170A may be provided with the ability to pass communications entered via security platform app 170A to third party communication platforms for relay to the other user. In such cases, security platform app 170A may be provided with the capability to record the entirety of a communication between or amongst users for storage in SICR 104 and inclusion in each participating user's secure profile (with timestamps and other authenticating information). In other circumstances, security platform app 170A may be utilized to initiate a third party communication application; security platform app 170A may in such cases communicate information about the interaction (such as timestamp, geolocation, user authenticating information, and interaction authenticating information) to SOP 100 for inclusion in SICR 104 and each participating user's security profile.

For in-person interactions, interaction parties may be prompted to affirmatively acknowledge the start and end of an in-person interaction, such as via selection of associated indicia on display screen 180 of mobile device 120C, with the selections being transmitted to SOP 100 and stored in SICR 104 in association with the users involved and the associated interaction. In some embodiments, additional data logging may be conducted by a user device 120 and/or SOP 100 during the course of an in-person interaction, such as GPS information and/or cell tower information, mobile telephone call activity, mobile telephone text messaging activity, and the identity of Bluetooth devices or wireless networks pinged during the course of the interaction. In some embodiments, some or all interaction information may be deleted by SOP 100 after conclusion of the interaction (or some threshold time period thereafter) in order to minimize risk to a participating user's privacy.

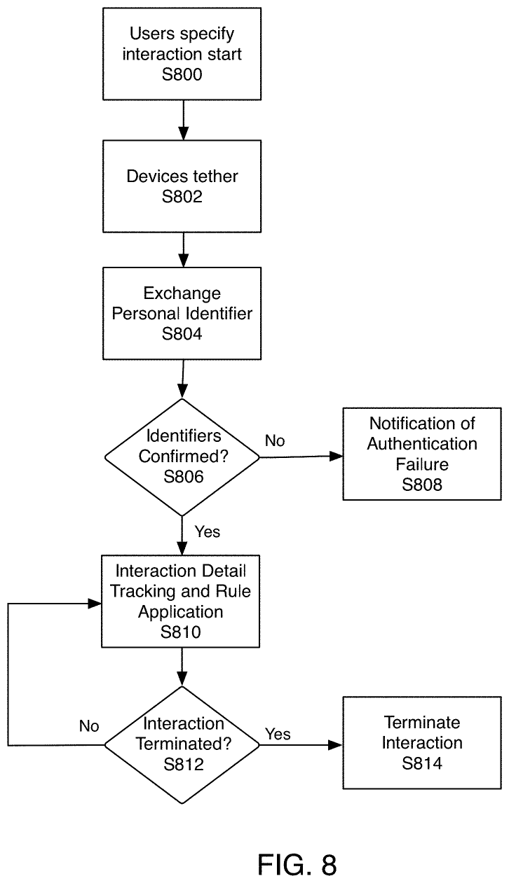

FIG. 8 illustrates an exemplary process that may be implemented for oversight of certain in-person interactions, potentially in the context of the users of FIG. 6, the communication network of FIG. 1 and each user having a mobile device 120C as illustrated in FIG. 2. In step S800, users 600 and 610 of mobile devices 120C each utilize security platform app 170A in order to indicate the start of an in-person interaction. In step S802, user 600 and user 610 utilize security platform app 170A to tether their mobile devices together. Tethering mobile devices may include, in some embodiments, association of the devices with one another in an interaction record maintained on SOP 100. Devices being tethered may cause various types of information associated with each device being shared into the SOP 100 transaction record. For example, when devices are tethered, geolocation data for each device may be shared into one or more common records in SOP 100.

In step S804, each user may be prompted to enter a confidential personal identifier, such as a Personal Identification Number (PIN) or password, into each other user's mobile device. The identifier entry process of step S804 may be used for interactions where it is desirable to confirm the presence of another user. Identifiers may be entered using security platform app 170A on a mobile device 120C. The identifiers entered may then be transmitted via network 115 to SOP 100 for confirmation (such as comparison to a previously-stored identifier associated with the user being confirmed) (step S806). A confirmation of user presence due to successful identifier entry may be stored within SOP 100 and also transmitted back to mobile device 120C for display on display 180 by security platform app 170A. In some embodiments, a “selfie” photograph may be used as an identifier, in which case SOP 100 may perform a facial recognition comparison with a previously-stored photo of the individual to confirm presence during the interaction. In some embodiments, other types of biometric data may be used as an identifier (such as fingerprint scan, or facial characteristics).

If confirmation of user identifiers in step S806 fails, then SOP 100 may initiate various notifications of user authentication failure (step S808). Such notifications may include one or more of: display of a user authentication warning on display 180 of device 120C by security platform app 170A; transmission by SOP 100 of notifications to trusted contacts of a user involved in an interaction with another individual for whom authentication failed (such as text message, email, telephone call or app notification); identification of the interaction location and authentication failure to one or more third party data consumers 140 (such as a local law enforcement agency); or other types of notifications.

If confirmation of user identifiers in step S808 succeeds, then in step S810, interaction detail tracking and rule application may be initiated. Interaction detail tracking may involve enhanced collection of information concerning users involved in a transaction, as described above (e.g. real-time location tracking, external communication tracking, and the like), as well as storage of such additional interaction detail by SOP 100 in an interaction security record. In some embodiments, the interaction security record may be initialized or created upon confirmation of participation in an interaction by the individual(s) involved in the interaction. In some embodiments, the one or more users involved in an interaction may be queried for biometric authentication in connection with initiation of an interaction security record, with provided biometric data (or encrypted and/or hashed derivatives thereof) optionally stored within the interaction security record to facilitate subsequent verification of record data provenance.

Rule application in step S810 may involve application of predetermined rules to interaction-related information. Rules may be determined based on, for example, user preference or customization, or the nature of an interaction type. In step S810, each user may have rules applied to the totality of information available and associated with an interaction, which may include, for example, another user's device location, and/or movement of other users outside of a predetermined geographic area (i.e. reverse geofencing). In some embodiments, rules may be applied in step S810 by SOP 100, a user device 120, or combinations thereof.

In step S812, a determination is made as to whether an interaction should be terminated. Termination of an interaction may be triggered by one or more criteria, such as: one user specifying completion of an interaction, multiple or all involved users specifying completion of an interaction, or movement of devices involved in an interaction more than a threshold distance apart from one another. In some embodiments, the threshold distance may be determined horizontally, e.g. based on distance as reflected on a map. In other embodiments, the threshold distance may include a vertical threshold distance, which may be included in a single distance criteria (e.g. three-dimensional distance) or which may be a separate distance criteria (e.g. applying a threshold distance of 200 feet horizontally, but having a threshold distance vertically of 20 feet to trigger when one of the devices travels to another floor in a high rise hotel). In the interaction is terminated (step S814), then the interaction detail tracking and rule application of step S810 is stopped. Otherwise, it continues.

One example application of the interaction tracking and rule application process of FIG. 8 includes an individual meeting an unfamiliar individual for a business purpose, such as a realtor meeting a prospective buyer to view a property. In such a use case, the user authentication, enhanced information tracking and automated notifications described above may be useful in deterring bad actors or inappropriate actions by individuals involved in the interaction. In such an example, it may be desirable in step S812 to preclude termination of an interaction until the other party has moved as least a threshold number of miles away from the realtor's location, thus inhibiting another party from leaving and promptly returning to the realtor's location, or waiting until the realtor departs a location at which a meeting occurred.

Another example application of the interaction tracking and rule application process of FIG. 8 includes a group of individuals attending a party, bar or other function together. The individuals may tether their mobile devices, such that location information is reported and tracked by SOP 100. Rule application in step S810 may include transmitting notifications to all tethered devices if any one of the devices leaves a specified geographic area.

Optionally, in such an embodiment, rule application in step S810 may include periodic querying of users of tethered devices for authentication (e.g. biometric authentication or secret key) using the users' mobile devices 120C in order to validate that each individual is still in possession of their device (and therefore, still at the location associated with their device). Exemplary modes of biometric authentication could include, e.g., fingerprint scan, or facial recognition. Such periodic user authentication may help avoid alerting failures in the event that, for example, an individual's mobile phone is left in a bar when the individual is kidnapped and removed from an allowed geographic area.

Another operation that may be desirable in some embodiments of rule application in step S810 is triggering of user authentication requests in response to network disconnection (e.g., in the event of device failure or power-down) for any device within the group of tethered devices. In particular, when communications with a first tethered device are interrupted, other tethered devices could be queried for authentication of the user associated with the first (disconnected) tethered device. Disconnected device authentication could include biometric authentication of the disconnected device user, entry by the disconnected user of a secret key or passcode into another tethered device, or confirmation of safe condition of the disconnected device user by a trusted, authenticated user of another tethered device. Such types of disconnected device authentication could be utilized as a precursor to automated escalation or notification of law enforcement, thereby provided a mechanism to reduce “false alarm” reporting of potential safety problems.

Security oversight platform application 170A may also provide users with the ability to block other users from initiating interactions, and/or to report other users for inappropriate interactions. Blocking and/or reporting actions may include information descriptive of a reason for the blocking and/or reporting (e.g. inappropriate content, profanity, belligerence, threats of violence, etc.) Blocking and reporting actions may be communicated to SOP 100 and stored within SICR 104 associated with both the reporting and affected users. In some embodiments, some or all blocking and reporting actions may be reviewed (whether by human or automated reviewers) for, e.g., escalation to law enforcement authorities (such as upon detection of possible imminent threat) and/or additional monitoring (such as geolocation tracking to assess proximity of the reported user to the reporting user).

Information associated with authentication and oversight of interactions initiated using processes such as that of FIG. 5 may be utilized in a variety of ways, including, for example, by law enforcement authorities in investigating events related to individuals having engaged in interactions with one another.

Interaction Risk Recommendations

In some embodiments, SOP 100 may utilize user profile information, such as that stored within SICR 104, in order to present users with an assessment of risk associated with a proposed interaction with another user, such that individuals may continue (or not continue) with contemplated interactions having a greater understanding of the risks involved.

Interaction risk recommendations may be derived using a variety of information and criteria. The nature of a proposed interaction may be weighed in making a risk recommendation. For example, a proposed nighttime dating interaction may be deemed to involve greater risk than a daytime meeting for sale of low-value goods. The geolocation of a proposed interaction may be weighed (potentially including how populated the location is, the prevalence of crime in the proposed location, etc.). The interaction risk recommendation may further evaluate the information stored in SICR 104 regarding the other party to the proposed interaction. For example: individuals with extensive positive interaction history may be assessed to have a lower interaction risk than individuals with negative interaction history or a lack of interaction history; individuals with events on a criminal background check may be assessed to have a higher interaction risk than individuals having a clean criminal background check. These and other factors may be utilized by SOP 100 in generating an interaction risk recommendation.

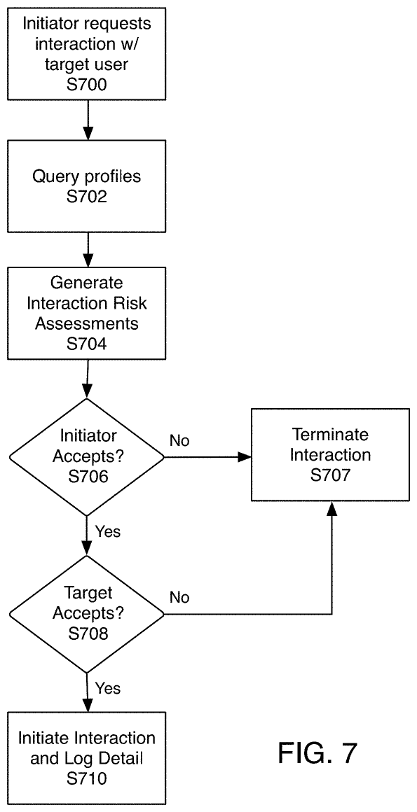

FIG. 7 illustrates an exemplary interaction process, analogous to that of FIG. 5, but further involving presentation of an interaction risk assessment prior to engagement in a proposed interaction. In step S700, a user requests an interaction with another user (analogous to step S504). In step S702, SOP 100 queries SICR 104 for profile information concerning the proposed interaction parties. In step S704, SOP 100 generates an interaction risk assessment. In step S706, SOP 100 transmits the interaction risk assessment to a user device 120 for presentation to the user and querying for acceptance. If the initiating user is unsatisfied with the risk assessment, the initiating user may terminate the proposed interaction (step S707). Otherwise, if the initiating user desires to continue with the proposed interaction, the target user may be presented with the risk assessment for the initiating user (e.g. via transmission from SOP 100 to a user device 120 for presentation on a display screen) and queried for acceptance (step S708). The target user may terminate the interaction (step S707) or continue, in which case the proposed interaction is initiated with SOP logging interaction details into an interaction security record (step S710, analogous to step S510).

Automated Notifications and Escalation Processes

Once a user-to-user interaction is initiated, a variety of notification and escalation processes may be utilized to provide increased comfort and security during monitored interactions. In some circumstances, automated notifications may be configured and implemented associated with a particular interaction. Such notifications may be based on interaction type, user preferences and other criteria such as geolocation, time, user interactions with security platform app 170A, and the like.

An automated notification mechanism may be implemented for planned in-person interactions such as product sales (such as may be arranged using Craigslist) or a date (such as may be arranged using a dating app such as Tinder or via a social networking application). Prior to the interaction, a participant may specify the planned time and location for the interaction, as well as an expected duration. In some circumstances, notifications may be automated, based on geolocation. For example, a user may identify a spouse, friend, parent or other trusted contact for automated notification when the user: departs for the interaction, arrives at the location of the interaction, departs the location of the interaction, and returns to a known home or office location.

Geolocation may also be utilized as a criterion for providing notifications (or escalations, described below). For example, a user may configure SOP 100 to provide notifications for arrival and departure of an interaction event, but only for events taking place outside a user's hometown or neighborhood.

Time (absolute time and/or elapsed time) may also be utilized as a criterion for notifications. For example, SOP 100 may be configured to initiate notifications to predetermined contacts (or escalation, as described below) if a threshold period of time elapses (e.g., a user fails to depart an interaction location prior to a threshold period of time elapses from the user's arrival thereto, or a user fails to return home prior to a threshold period of time elapsing after arriving at an interaction location). As another example, SOP 100 may be configured to provide notifications based on absolute time, e.g. providing additional notifications for interactions occurring during nighttime hours.

In addition to notifications, SOP 100 may also be configured to provide automated escalation of monitoring or assistance. For example, criteria may also be configured for escalation of an interaction to a security service provider associated with SOP 100. Such service providers may attempt to contact a user (e.g. by phone or through messaging or communication functions implemented by security platform app 170A) to verify the user's safety and condition. In some embodiments, such users may be provided with multiple verified responses that may be provided to a security service provider; one or more responses may actually designate a safe condition (thus terminating the escalation), and one or more other responses may appear to terminate the escalation (e.g. deactivating alarms and ending a query), but may in fact actuate response escalation (such as notification of law enforcement authorities or deployment of security service personnel), thereby allaying concerns of any perpetrators who may be actively threatening the victim user and monitoring the victim user's response to the security service provider inquiry.

In some embodiments, escalation criteria may also be defined to trigger escalation of an interaction to law enforcement authorities. In such circumstances, SOP 100 (whether automatically, such as through reporting to a law enforcement data consumer system 140, or manually by a SOP-affiliated security service provider) may rapidly provide detailed interaction details and user profile information to law enforcement authorities, improving their ability to respond rapidly, effectively and safely to potentially dangerous circumstances. For example, law enforcement authorities may be notified of a specific, potentially real-time location associated with a problem (as tracked by geolocation component 166 in mobile device 120C and reported to SOP 100), detailed information concerning each individual involved, and details concerning the intended nature of the interaction. Escalation processes may further include additional or different notification mechanisms, as may be configured to a user, to ensure that trusted individuals are notified and apprised of any problems and provided with an opportunity to assist the involved user and/or law enforcement authorities.

In some embodiments, security platform app 170A may provide users with tools, rendered on display screen 180, for use in manually triggering notifications or escalation. For example, a button may be provided for selection in the event that a user feels threatened during the course of an in-person interaction, triggering notifications to trusted individuals and/or law enforcement authorities as described elsewhere herein.

Affirmative Interaction Monitoring

In some use cases, it may be desirable to provide users with tools for affirmative monitoring or conduct of interactions.

For example, in a dating context, parties may desire to obtain memorialized expressions of affirmative consent from one another prior to engaging in certain types of activities, such as sexual relations. In such an application, each user may select an indicium rendered on a display screen 180 of a mobile device 120C associated with them, corresponding to an affirmative expression of consent. Such a selection may be communicated to a mobile device 120C associated with the other party to the interaction (such as via mobile notification triggered by SOP 100 in response to reporting of the selection to SOP 100 by the consenting user's device). The expression of consent may be further timestamped, location-tracked and otherwise authenticated and stored within SICR 104 in user profiles associated with each party to the interaction. The expression of consent may require user authentication, as described in connection with steps S804 and S806 of FIG. 8, and may further initiate tethering of devices analogous to step S802; as well as tracking of interaction detail and application of rules analogous to steps S810 and S812.

Multiple Service Aggregation of Profile Information

By implementing SOP 100 independently of P2P application servers 130, but enabling interactions between them, SOP 100 may aggregate relevant user information across multiple different types of interactions in order to develop a more comprehensive and valuable user profile. For example, a ridesharing application mobile app 170C that integrates with SOP 100 may query users to capture a “selfie” photo for purposes of authenticating identities of a driver and/or passenger (e.g. by matching the photo against a previously-captured photo), prior to initiating a ride. Photos captured in such an application may be transmitted to SOP 100 for timestamping and storage within an associated user profile in SICR 104. In turn, if the user subsequently engages in a P2P sale of merchandise arranged online and consummated in person, SOP 100 may present the photo to the other party or parties to the transaction as a recent photo, in order to help those other parties authenticate the person with whom they are interacting.

Data Sharing and Overlay

Data acquired by SOP 100 and/or security platform app 170A may also be utilized to enhance of overlay data maintained by third parties. For example, many municipalities may maintain networks of security cameras monitoring various locations, such as important intersections in a city. Time stamp and location data maintained by SOP 100 may be overlaid with municipality camera feed data, such as to determine camera locations passed by a user and the time of such passage; the time and location information may then be combined with the camera feeds to identify images of a user on the cameras. Such images may then be used, for example, to match against other camera feeds, to identify license plate information (if the individual is driving a vehicle) or the like.

Key Management System

SOP 100 may, in some use cases, store information that users deem to be private or sensitive. On the other hand, SOP 100 may need to interact with a variety of third-party, uncontrolled information systems and data users. Therefore, in some embodiments, SIM 110 will include a key management system (KMS) component. The KMS may provide capabilities such as encryption key generation, encryption and decryption, wrapping and unwrapping of data payloads, and key derivation using the keys from the KMS to communicate with other relevant systems. KMS may be implemented using, for example, a cryptographic application programming interface (such as the Microsoft CryptoAPl) to interact with a number of cryptographic service providers implemented locally within SOP 100.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or appended claims.

1. A computer-implemented method for implementing a secure interaction amongst two or more users of mobile electronic devices engaging in the interaction via a third party application platform, the method comprising:
receiving, by a network-connected security oversight server, user profile data for storage within user security profiles, each user security profile associated with one of the users;
receiving, from each of the two or more users, consent to interaction monitoring;
logging, by the security oversight server for incorporation into the user security profiles: (a) communications amongst the two or more users relating to the interaction using a third party application platform, and (b) location information reported by a mobile electronic device associated with each user; and
implementing, by the security oversight server, a transaction monitoring process during a period of time in which the security oversight server determines a secure interaction to be taking place.

2. The method of claim 1, in which the third party application platform comprises one or more servers implementing an online dating application.

3. The method of claim 1, in which the third party application platform comprises one or more servers implementing a peer-to-peer commercial transaction platform.

4. The method of claim 1, in which the user profile data comprises personally-identifiable information associated with a user.

5. The method of claim 1, in which the user profile data comprises biometric data associated with a user.

6. The method of claim 5, in which the biometric data associated with a user comprises a profile photo captured at the time of profile creation by a digital camera integrated within one of said mobile electronic devices.

7. The method of claim 6, further comprising:
during the interaction, receiving by the security oversight server an interaction photo of a user captured by said camera of an associated user mobile device;
evaluating similarity of the user's interaction photo with the user's profile photo; and
transmitting to one or more of the mobile electronic devices an indication of the similarity of the user's interaction photo with the same user's profile photo; whereby the identity of one or more of said users may be confirmed or denied.

8. The method of claim 1, in which the step of logging, by the security oversight server for incorporation into the user security profiles, location information, is performed for a user during a predetermined period of time surrounding a planned in-person interaction involving the user.

9. The method of claim 8, in which the predetermined period of time surrounding a planned in-person interaction involving the user comprises the time during which the planned in-person interaction is taking place.

10. The method of claim 8, in which the predetermined period of time surrounding a planned in-person interaction involving the user comprises a time period proximate the planned in-person interaction during which the user's reported location is within a predetermined distance of one or more other users with who the planned in-person interaction takes place.

11. The method of claim 1, in which the location information comprises location information stored on the mobile electronic device prior to the period of time in which the security oversight server determines a secure interaction to be taking place.

12. The method of claim 1, in which the step of implementing a transaction monitoring process during a period of time in which the security oversight server determines a secure interaction to be taking place comprises receiving, by the security oversight server, a report from one or more of said users indicating that the secure interaction is taking place.

13. The method of claim 1, in which the step of implementing a transaction monitoring process during a period of time in which the security oversight server determines a secure interaction to be taking place comprises: forwarding information characterizing the transaction to one or more network-connected third party servers utilized by law enforcement authorities.

14. The method of claim 13, in which the step of reporting information characterizing the transaction to one or more network-connected third party servers utilized by law enforcement authorities comprises reporting of the interaction location, information identifying the users involved in the interaction, and information descriptive of the nature of the interaction.

15. The method of claim 14, further comprising adjusting deployment of law enforcement personnel based at least in part on said information characterizing the transaction.

16. The method of claim 13, in which the step of implementing a transaction monitoring process during a period of time in which the security oversight server determines a secure interaction to be taking place further comprises: transmitting information characterizing the transaction to one or more network-connected mobile electronic devices utilized by dispatched law enforcement personnel.

17. The method of claim 16, in which the step of implementing a transaction monitoring process during a period of time in which the security oversight server determines a secure interaction to be taking place further comprises: transmitting one or more notifications to an individual other than the two or more users.

18. The method of claim 13, in which the step of in which the step of reporting information characterizing the transaction to one or more network-connected third party servers utilized by law enforcement authorities is performed in response to satisfaction of one or more predetermined criteria determined by the two or more user.

19. The method of claim 1, further comprising transmitting, by the security oversight server, to one or more of the users, an interaction risk recommendation based at least in part on said profile information associated with the users.

20. A computer-implemented method to conduct secure, monitored, user-authenticated communications conducted via one or more third party communication platforms, comprising:
obtaining, by a third party communication platform, consent from two or more users for monitoring of communications by a security oversight server, said communications conducted at least in part via a mobile electronic device associated with each user;
authenticating each of the two or more users with the security oversight server;
receiving from at least one of said users, by the security oversight platform, an interaction request comprising information indicative of a period of time during which the interaction takes place;
receiving from the third party communication platform, and storing, by the security oversight server within a secure interaction communication repository, communications conducted amongst the two or more users via the third party communication platform during the period of time during which the interaction takes place; and
implementing, by the security oversight server, a transaction monitoring process during the period of time in which the interaction takes place.

21. The method of claim 20, in which the transaction monitoring process comprises receiving and storing, by the security oversight server, location information reported by said mobile electronic device associated with each user.

22. A computer-implemented method for a plurality of individuals, each using a network-connected mobile electronic device, to monitor the proximity of one another during an in-person interaction event, the method comprising:
receiving by a network-connected server, from each of a plurality of network-connected mobile electronic devices, specification of participation of an associated user in, and start of, an in-person interaction;
receiving, during the in-person interaction, from each of the plurality of network-connected mobile electronic devices, reporting of device locations, said device locations stored within an interaction security record associated with the in-person interaction;
monitoring said device locations during the course of the in-person interactions; and
transmitting one or more notifications to a law enforcement authority, the notification initiated based at least in part on said device locations during the in-person interaction, and the notifications containing information from said interaction security record.

23. The method of claim 22, further comprising receiving, by the server from each interaction participant user, a confidential personal identifier associated with the interaction participant user, for comparison to a previously-specified confidential personal identifier to confirm the user's participation in the interaction.

24. The method of claim 23, in which the confidential personal identifier comprises a photograph of the interaction participant user taken using a mobile electronic device having an integrated camera and associated with the user.

25. The method of claim 22, in which the step of transmitting one or more notifications based at least in part on said device locations comprising transmitting a notification to one or more of the mobile electronic devices associated with the plurality of individuals, in the event that one or more of said mobile electronic devices reports a location separated from each of the other mobile electronic device locations by a threshold distance.

26. The method of claim 25, wherein the threshold distance comprises a threshold vertical distance.

27. The method of claim 22, in which the step of transmitting one or more notifications based at least in part on said device locations comprising transmitting a notification to one or more of the mobile electronic devices associated with the plurality of individuals, in the event that one or more of said mobile electronic devices reports a location outside of a predetermined geographic area.

28. The method of claim 22, further comprising terminating the in-person interaction automatically by the server after the locations are separated by a threshold distance.

29. A system for monitoring peer-to-peer interactions between two or more individuals comprising:
a plurality of user mobile electronic devices, each user mobile electronic device associated with a user and comprising a processor, digital memory, and a wireless network interface enabling the mobile electronic device to send and receive data communications over a wide area data network; and
an oversight platform server, interacting with the plurality of user mobile electronic devices via the wide area data network, the oversight platform server comprising:
a secure communications module implementing user-to-user communications within one or more third party application servers; and
a secure repository for in-app communications, storing information characterizing communications between the user mobile devices;
wherein the oversight platform server maintains and utilizes a common body of knowledge concerning the plurality of users, derived at least in part from information collected by the secure communications module and secure repository for in-app communications, in order to transmit interaction risk recommendations to one or more recipient electronic devices.

30. The system of claim 29, in which the one or more recipient electronic devices comprises one or more of the plurality of user mobile electronic devices.

31. The system of claim 29, in which the one or more recipient electronic devices comprises one or more devices other than the plurality of user mobile electronic devices.

32. The system of claim 31, wherein one or more of said recipient electronic devices is identified based at least in part by one or more escalation criteria determined by one or more of said users.

33. The system of 29, in which the oversight platform server further implements one or more web applications, each web application providing functionality accessible by an application implemented by the one or more third party application servers.

34. The system of 29, in which the common body of knowledge further comprises telecommunications and network security data reported to the security oversight platform server by one or more of said user mobile electronic devices.
